(19) United States
(12) Patent Application Publication
(10) Pub. No.: US 2025/0205116 A1
(43) Pub. Date: Jun. 26, 2025

(54) Apparatus and Related Method for Tracking Administration of Medication

(71) Applicant: Felipe Tabet, Saskatoon (CA)

(72) Inventor: Felipe Tabet, Saskatoon (CA)

(21) Appl. No.: 18/981,903

(22) Filed: Dec. 16, 2024

Related U.S. Application Data
(60) Provisional application No. 63/615,710, filed on Dec. 28, 2023.
(60) Provisional application No. 63/613,213, filed on Dec. 21, 2023.

(51) Int. Cl. A61J 7/04

(52) U.S. Cl. CPC A61J 7/0418; A61J 2205/10

(57) ABSTRACT

A device for tracking administration of medication comprises a first stationary body attached to, or integrated into, a medication container and carrying on a topside thereof indicia representative of timing intervals among which the medication is to be administered, and one or more upper discs including at least a first upper disc supported for rotation relative to the lower body and configured to cooperate with the indicia to indicate, to the user, an administration time of the medication. At least one of the upper discs is made of Printable Material so as to be configured to receive Ink for personalizing the device. A related method of use includes personalizing the tracker which can include (i) patient information, (ii) medication information/instructions and (iii) pharmacy/healthcare provider/medication manufacturer information which can include a logo of the business, contact information or QR codes.

### CROSS-REFERENCE TO RELATED APPLICATIONS

This application claims benefit under 35 U.S.C. 119 (e) of U.S. Provisional Applications No. 63/613,213, filed Dec. 21, 2023 and 63/615,710, filed Dec. 28, 2023, each of which is incorporated herein by reference in its entirety.

### FIELD OF THE INVENTION

The present invention relates generally to an apparatus and related method for tracking administration of medication.

### BACKGROUND

It is known to provide a medication tracking device to keep track of medication to be administered. Such devices may be operated to indicate a future administration time of the medication, or a last administration time, based on which a user can determine a subsequent administration time. Often, such devices are complex in construction and may not be suited to bear or display information about a patient receiving the medication or medication information or distributing pharmacy so that contact information enabling follow-up about the administration of the medication, such as dosage or schedule, is readily possible without searching other resources for the same information, such as Internet webpages.

### SUMMARY OF THE INVENTION

According to one aspect of the invention there is provided a device for tracking administration of medication stored in a container, the device comprising:
a lower body configured to reside in stationary relationship to said container, and having a topside carrying indicia that are representative of timing intervals among which the medication is to be administered;
one or more upper discs, including at least a first upper disc having an underside arranged to face the lower body and an opposite topside arranged to face away from the lower body and the container, wherein the first upper disc is supported for rotation relative to the lower body and about a rotational axis projecting from the topside of the lower body and intersecting a plane of the first upper disc within a periphery of the first upper disc, wherein the first upper disc is configured to cooperate with the indicia on the topside of the lower body to indicate, to a user and from among said timing intervals, an administration time of the medication;
wherein at least one of the upper discs is made of Printable Material so as to be configured to receive Ink for personalizing the device.

This medication tracker is readily personalizable before or after manufacturing, for example by the user in the latter case. For example, the topside(s) of the printable first upper disc(s) may be personalized with patient information, medication information such as, for example, dosage information, or pharmacy, healthcare provider (e.g. clinic) or medication manufacturer information including, for example, a logo of the pharmacy, healthcare clinic, or medication manufacturer, contact information of the pharmacy or healthcare provider, and/or one or more QR codes or other machine-readable codes, for example having encoded therein a hyperlink to a webpage associated with the pharmacy, healthcare provider or particular medication, for example instructional video or written content concerning the particular medication (e.g. side effects, drug interactions, etc.) and its method of administration, or marketing material or online catalogue of the pharmacy.

The user may be a patient who consumes the medication or a healthcare provider or other caretaker administering the medication to the patient.

Typically, the rotational axis is centrally located on both the lower body and the upper disc(s).

In embodiments where the lower body is embodied separately of the container and is mountable thereto, the underside of the lower body forms a planar surface. This may act to increase an area of the mounting surface to enhance attachment to the container.

In one embodiment, the lower body is made of Printable Material so as to be configured to receive Ink for personalizing the device.

Preferably, the one or more upper discs are rotatably connected to the first body by a shaft assembly including a shaft defining the rotational axis and at least one stopper supported at or adjacent an end of the shaft and in distal relation to the first body, so as to resist axial movement of the one or more upper discs away from the first body.

Preferably, the shaft assembly includes a base at or adjacent to a fixed end of the shaft opposite to the distal end thereof, wherein the base is in the form of a planar member oriented in a substantially radial plane of the rotational axis.

Preferably, in embodiments where the lower body is embodied separately of the container, the base is disposed to one side of the lower body and in opposite relation to the second body so as to be arranged between the lower body and the container in the mounted condition.

In one embodiment, the device further includes an adhesive substrate attachable to the base of the shaft assembly in opposite relation to the first body for bonding the shaft assembly to the container.

In some embodiments, the one or more upper discs include a second upper disc supported for rotation relative to the first upper disc about the rotational axis, wherein the second upper disc is disposed oppositely across the first upper disc from the lower body such that the first upper disc resides intermediately of the lower body and the first upper disc bodies along the rotational axis, wherein the topside of the first upper disc carries additional indicia representative of dosage quantities additional timing intervals of different measure than those on the lower body, and wherein the second upper disc is configured to cooperate with the additional indicia on the topside of the first upper disc to indicate, to the user, dosage or supplemental timing information concerning said administration time of the medication.

The second upper body may be made of Printable Material so as to be configured to receive Ink for personalizing the device.

Preferably, the second upper body is planar.

Preferably, the first and second bodies are planar.

According to another aspect of the invention there is provided method for tracking administration of medication stored in a container, the method comprising:
providing a tracker for indicating a future administration time of the medication;
supporting the tracker on the container; and
before or after supporting the tracker on the container, personalizing the tracker which can include (i) patient information, (ii) medication information and/or (iii) pharmacy/healthcare provider/medication manufacturer information, which can include a logo of the business, contact information thereof, or one or more QR codes.

Preferably, providing a tracker comprises receiving a tracker in a manufactured state bearing indicia representing times at which the medication is to be administered.

Preferably, personalizing the tracker is performed by marking the tracker using Ink.

Marking the tracker using Ink may comprise handwriting.

Additionally or alternatively, marking the tracker using Ink may comprise imprinting with a stamp.

The method may further include discarding the container with the tracker attached thereto.

In one embodiment, when the tracker is provided in the form of a kit of plural constituent components, providing a tracker comprises receiving the kit in a disassembled state, in which the constituent components are disconnected, and the method further includes assembling the kit to form the tracker.

In one embodiment, the kit comprises a lower body configured to fixedly attach to the container, at least one rotational upper disc configured for rotational movement relative to the first lower body, and an interconnecting shaft assembly to support the at least one rotational disc in the rotational movement relative to the lower body.

According to another aspect of the invention there is provided a method of assembling a medication tracker comprising:
from among a plurality of preprinted or templated options for a lower body of the medication tracker, each having thereon a uniquely different set of timing indicia thereon that represent medication timing intervals of different interval length from one set to another, selecting a chosen one of said options based on a medication dosing schedule of an intended user; and
assembling, to a lower body component that embodied said chosen one of said options, one or more rotatable upper discs in positions overtop said lower body in positions rotatable relative thereto, including at least a first upper disc configured cooperate with the set of timing indicia on the topside of the lower body to indicate, to a user and from among said medication timing intervals, an administration time of the medication; and
before or after assembling said lower body and said one or more upper discs, personalizing at least one of said one or more upper discs with personalized readable content specific to said user.

The method may comprise, before assembling said lower body and said one or more upper discs, selecting from among a plurality of preprinted or templated options for the first upper disc, which differ from one another in at least one of: (a) inclusion or absence of additional indicia thereon cooperative with an optional second upper disc to provide further medicinal administration information in association with the administration time of the medication; (b) whether said additional indicia denotes dosage information or additional timing intervals that supplement the timing indicia on the lower body; or (c) a time scale of said additional timing intervals.

In some instances, the method comprises selecting one of said preprinted or templated options for the first upper disc that is characterized by inclusion of said indicia thereon, and assembling the lower body and said one or more upper discs includes assembly both said first upper disc and said optional second upper disc.

Alternatively, the method may comprise before assembling said lower body and said one or more upper discs, selecting said first upper disc from among differently sized upper disc options.

In some embodiments, the differently sized upper disc options are both configured to cooperate with the same set of indicia on the lower body.

Said differently sized upper disc options may comprise a large upper disc with a viewing window therein through said set of indicia are selectively viewable, and a smaller upper disc with a pointer thereon that points outwardly toward said set of indicia.

### BRIEF DESCRIPTION OF THE DRAWINGS

Preferred embodiments of the invention will now be described in conjunction with the accompanying drawings in which:

FIG. 1 illustrates a kit of modular components for assembling a uniquely customizable medication tracker capable of personalization to an intended user and application of the tracker to a medication container of that user.

FIG. 2A is a top plan view of one uniquely customized medication tracker assembled from a subset of the modular componentry of FIG. 1.

FIG. 2B is a cross-sectional view of the uniquely customized medication tracker of FIG. 2A.

FIG. 3A is a top plan view of another uniquely customized medication tracker assembled from a different subset of the modular componentry of FIG. 1.

FIG. 3B is a cross-sectional view of the uniquely customized medication tracker of FIG. 3A.

FIG. 4A is a top plan view of another uniquely customized medication tracker assembled from a different subset of the modular componentry of FIG. 1.

FIG. 4B is a cross-sectional view of the uniquely customized medication tracker of FIG. 4A.

FIG. 5 is an isolated bottom plan view of an adhesively equipped disc from the kit of FIG. 1, illustrating a removable backing with an optional back slit thereon that penetrates only the backing to facilitate removal thereof from the disc.

FIG. 6 is a cross-sectional view of a variant of the uniquely customized medication tracker of FIGS. 4A and 4B featuring optional inclusion of a separate adhesion disc, in alternative to adhesive coating of the underside of the adhesively equipped disc of FIG. 5, as an adhesive mounting interface for attaching the medication tracker to a medication container.

FIG. 7 illustrates another uniquely customized medication tracker assembled from a different subset of the modular componentry of FIG. 1, and installed on the cap of a medication bottle.

FIG. 8 illustrates the uniquely customized medication tracker of FIGS. 4A and 4B, installed on a medication box.

FIG. 9 is a top plan view of another uniquely customized medication tracker assembled from a different subset of the modular componentry of FIG. 1.

### DETAILED DESCRIPTION

Before providing a detailed description of preferred embodiments with reference to the appended drawings illustrating the same, definition is provided for at least a subset of terms used regularly herein to aid an understanding of a non-exhaustive list of workable embodiments of the present invention.

Container: bottle, container, box or any other compartment used to store medication.

Printable Material: comprising any one of, or any combination of, the following: paper, natural paper, pulp paper, recycled paper, stone paper, synthetic paper, vinyl, polypropylene (PP) and polyester (PET) films, polymer-based sheets, cellulose derivatives, bioplastics, acetate films, polyethylene (PE) films, polycarbonate (PC) sheets, nylon sheets, glassine, coated papers, Tyvek® and other proprietary products, laminated papers, fiber-reinforced plastics (FRP), silicone sheets, bamboo paper, rice paper, latex sheets, thermal papers, and other ink-receptive, tone-receptive, thermal-printable, dye sublimation, lithography, UV-printable materials regardless of its specific composition, including but not limited to these examples.

Ink: For the purposes of this document, the term ‘Ink’ can be understood to encompass various processes of transferring information onto the tracker, including, but not limited to, inkjet printing, toner-based printing, thermal printing, dye sublimation, lithography, handwriting, stamping and UV printing.

Referring to the accompanying drawings, there is shown a Printable Material medication tracker, which is designed to assist individuals in tracking their medication schedule. It is a simple yet effective tool, primarily made of Printable Material, which makes it customizable, cost-effective, eco-friendly and environmentally sustainable. The tracker is intended for use with various medication containers, such as prescription bottles or medication boxes.

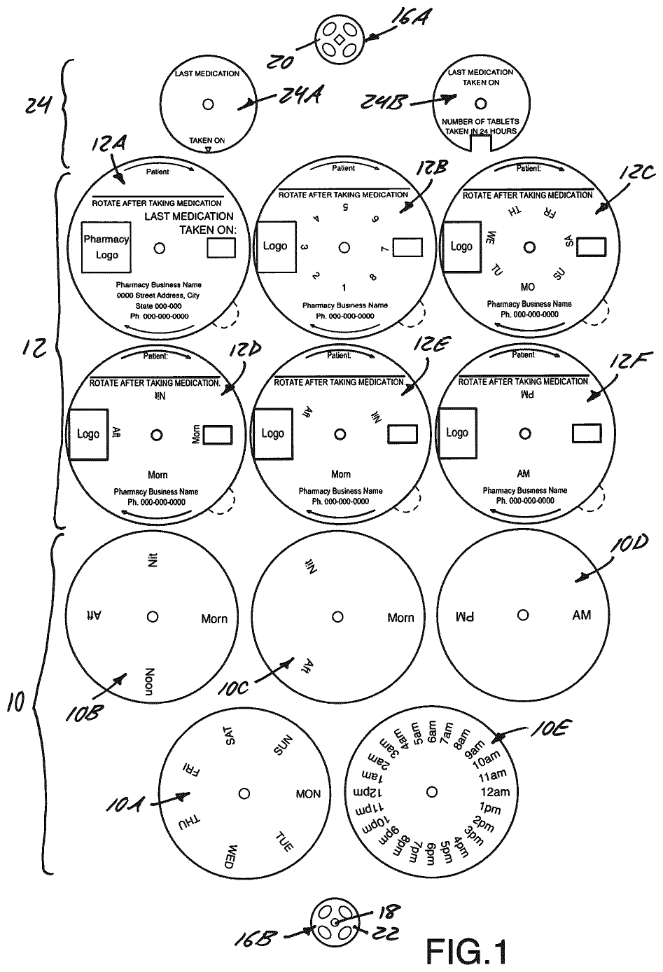

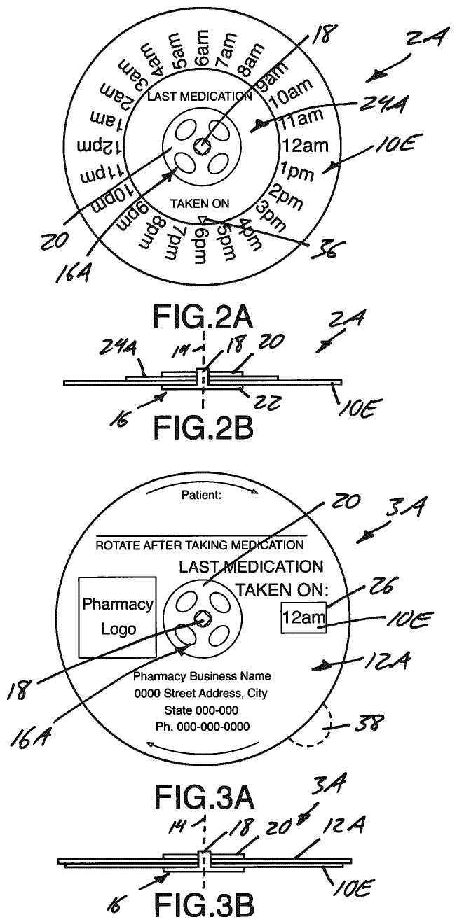

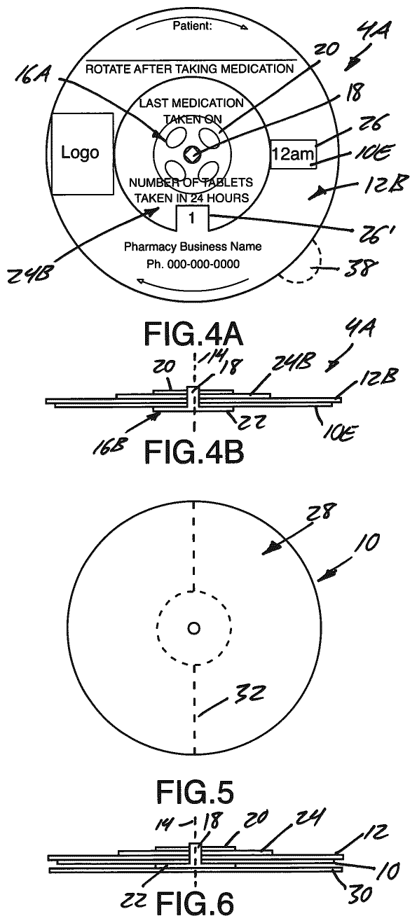

Referring initially to FIG. 1, illustrated therein is a kit of modular components, among which differently combined subsets thereof can be assembled to form differently customized implementations of a personalizable medication tracker, different assembled examples of which are illustrated in FIGS. 2A through 4B. The kit features a plurality of interchangeable lower discs 10A-10E of equal size but characterized by different printed indicia thereon, a plurality of interchangeable large upper discs 12A-12F likewise of equal size but characterized by different printed indicia thereon, and a plurality of interchangeable small upper discs 24A-24B of equal size but characterized by different printed indicia thereon. Each instance of a differently customized medication tracker features a selected one of the lower discs 10A-10E, in some instances accompanied by a selected one of the small upper discs 24A-24B but not one of the large upper discs 12A-12F (an example of which is shown in FIGS. 2A-2B), in other instances accompanied by a selected one of the large upper discs 12A-12F but not one of the smaller upper discs 24A-24B (an example of which is shown in FIGS. 3A-3B), and in another instances accompanied by both one of the large upper discs 12A-12F and one of the smaller upper discs 24A-24B (one example of which is shown in FIGS. 4A-4B, and another in FIG. 6). In any instance referring generically to one of the discs, a purely numerical reference (10, 12 or 24) without an alphabetic suffix is used. When generic reference intended to encompass either a large upper disc 12 or small upper disc 24, it is referred to simply as an upper disc 12, 24 with no sizing designation (large or small).

Generally speaking, each instance of an assembled tracking device comprises at least a lower disc 10 configured to attach in fixed relation to a container 100 when installed thereon in a mounted condition, and at least one upper disc 12, 24 supported for rotation relative to the first body and about a rotational axis 14 projecting from a topside of the first body 10 and intersecting a plane of an underside of the upper disc 12, 24 within a periphery thereof.

The lower disc 10 has an underside arranged to face the container 100 and, in some embodiments, carrying an adhesive for bonding thereto, and a topside opposite to the underside and carrying indicia that is at least partially, and in some cases fully, representative of times at which the medication is to be administered.

The upper disc 12, 24 is configured to cooperate with the indicia on the topside of the first body to indicate, to the user, a most recent or future administration time of the medication. The upper disc 12, 24 is made of Printable Material and is thereby configured to receive Ink thereon for the purpose of personalizing the device to a user, for example to the intended consumer (i.e. the patient) of the medication stored in the container 100, whether or not the user self-administers the medication or relies on a caretaker for timely dispensing and consumption of the medication according to a prescribed, recommended or otherwise followed administration schedule.

Generally speaking, cooperation with the indicia on the topside of the lower disc 10 is achieved by (i) a substantial covering, by the upper disc 12, of the indicia on the first body 10 except for a particularly selected one of the indicia that is indicative of the future administration time, or (ii) an indicator on the upper disc 24 that points to the indicia indicative of the future administration time.

In the illustrated embodiments, the rotational axis 14 is centrally located on both the lower disc 10 and the upper disc 12, 24. Furthermore, the lower and upper discs have a common shape, in this case planar discs that are each, at least predominantly, circular in outer perimeter, and the discs are disposed in concentric relation to each other, with their at least predominantly circular outer perimeters sharing a same radial center at which the rotational axis 14 resides

The underside of the lower disc 10, which in at least some instances forms a mounting interface of the tracker, forms a planar surface. This may act to increase an area of this mounting interface to enhance attachment to the container. In the illustrated embodiments, both the topside and underside of the lower disc 10, and the topside and underside of teach upper disc 12, 24, form respective planar surfaces of parallel relationship to one another.

In the illustrated embodiments, the lower disc 10 is made of Printable Material so as to be configured to receive Ink for personalizing the device. This increases an available display area of the device available for personalization, on which more information can be readably embodied for display to the user, though in other embodiments, the totality of personalizable display area may instead be embodied solely by the upper disc(s) 12, 24.

Each upper disc 12, 24 is rotatably connected to the lower disc 10 by a shaft assembly 16, which includes a shaft 18 that defines the rotational axis 14 and at least one stopper 20, which stopper resides at or adjacent an end of the shaft 18 and in distal relation to the lower disc 10 and radiates outwardly from the shaft, so as to resist axial movement of the upper disc(s) 12, 24 away from the lower disc 10. The shaft assembly 16 includes a base 22 at or adjacent a fixed end of the shaft 18 that resides opposite to the distal end thereof, wherein the base 22 is in the form of a planar member oriented in a substantially radial plane of the rotational axis, and likewise radiates outwardly from the shaft 18. The base is disposed to one side of the lower disc 10 and in opposing relationship thereacross to the upper disc(s) 12, 24 so as to be arranged between the lower disc 10 and the container 100 when the medication tracker is installed thereon in the mounted condition.

In at least one preferred embodiment, the device further includes an adhesive substrate attached or attachable to the base 22 of the shaft assembly so as to reside in opposing relationship to the first body 10 and thus be usable for bonding of the shaft assembly 16 to the container 100.

In some examples, the assembled medication tracker includes both a large upper disc 12 supported in overlying adjacency and relative rotatability to the lower disc 10, and a smaller upper disc 24 supported in overlying adjacency and relative rotatability 24 to the larger upper disc 12, whereby the smaller upper disc 24 rotatable relative to the underlying larger upper disc 12 about the rotational axis 14. The smaller upper disc 24 is disposed to one side (above, in the illustrated and described orientation) of the larger upper disc 12 in opposing relationship thereacross to the first body 10 such that the larger upper disc 12 is situated intermediately between the other two discs 10, 24 along the rotational axis 14.

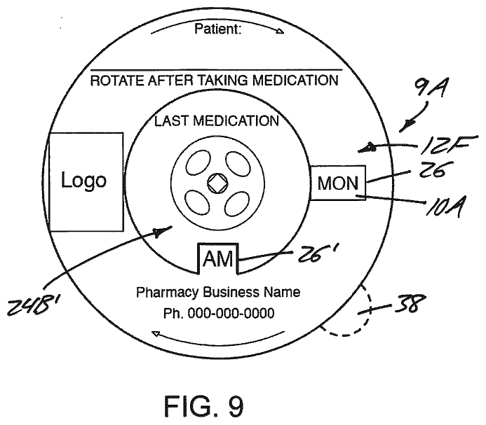

The topside of the larger upper disc 12, for implementations of the medication tracker also including a small upper disc 24, may carry indicia representative of differently scaled times of greater or lesser interval to one another than the timing intervals represented by the indicia on the topside of the first body 10. Examples of this are given by selectable large upper discs 12C-12F, of which disc 12C embodies days of the week thereon, denoting greater (longer) timing intervals than the lesser (shorter) time of day intervals denoted by the indica on selectable lower discs 10B-10E, while discs 12D-12F embody times of day thereon of lesser (shorter) timing intervals than the greater (longer) day of the week intervals denoted by the indicia on selectable lower discs 10A. So in the instances where small upper disc 24B is used with one of the large upper discs 12C-12F with timing indicia, the small upper disc 24B is configured to cooperate with the differently scaled timing indicia on the topside of the large upper disc 12C-12F to indicate, to the user, in combined cooperation with (i.e. complimentary relation to) the large upper disc's 12 indication of other timing indicia on the lower disc, a recent or future administration time of the medication. In one non-limiting example, the indicia on the topside of the selected lower disc 10A indicates days of the week, while the ndicia on the topside of a selected large upper disc 12D-12F is of subscale relation to those days of week indicia and instead indicates different times of day, as example of which is demonstrated by the medication tracker 9A in FIG. 9, where small upper disc 24B′ is a variant of 24B with the dosage counter text removed therefrom given use of this small upper disc 24B′ to indicating timing not dosage count or measurement. In another example, not illustrated, the indicia on the topside of the lower disc 10 may indicate times of the day by category (a.m. and p.m., morning and afternoon; morning, afternoon and night; or morning, noon, afternoon and night), while the subscale indicia on the topside of the large upper disc 12 indicates times of the day by hour, for example in a manner similar to the illustrated dosage tracking disc 12B, but with hour indicia (e.g. a set of twelve hour indicia evenly arrayed around the center of the disc like the set of eight illustrated dosage indicia). Alternatively, the indicia on the topside of the lower disc 10 may denote subscale times of lesser (shorter) interval relative to greater (longer) timing intervals denoted by the indicia on the large upper disc 12, for example with days of the week indicated on the large upper disc 12 and times of the day (by hour or category) indicated on the lower disc 10.

In at least some embodiments, the small upper disc 24 too is made of Printable Material, thereby being configured to receive Ink for personalization of the device. In the illustrated embodiments, the small upper disc 24, like the first and second bodies, is planar, and more particularly is a planar disc that is, at least predominantly, circular in outer perimeter.

With reference to the illustrated embodiments, the large upper disc 12 may be a disc of Printable Material with a cut-out window 26 therein that allows the user to view a subset of the indicia on the topside of the underlying lower disc 10, which viewable subset is changeable by way of relative rotation between the lower disc 10 and large upper disc 12 to change which of the indicia underlies the cut-out window 26 and is therefore visible therethrough. This large upper disc 12, in at least some instances, denotes a primary interface for the user, for example to convey useful information thereto, which information may include instructions, marketing information (healthcare provider, pharmacy or manufacturer branding), patient information (patient name), and medication-related information (medication name, dose, etc.), and QR codes. Such QR codes, or other machine readable codes readable by a user's smartphone or tablet computer, may, for example, having encoded therein a hyperlink to a webpage or other online content associated with the pharmacy or medication, for example instructional video or written content concerning the medication and its administration, or marketing material or online catalogue of the pharmacy. Accordingly, in at least some embodiments, personalization of the medication tracker may include application thereto of QR code, for example by the dispensing pharmacy, which QR code may be selected and applied according to the particular medicinal content of the medication container, linking to instructional video or other visible/readable informational content (side effects, drug interactions, etc.) hosted online at a URL encoded in that QR code.

The lower disc 10 may likewise be a disc of Printable Material, and may be equal to or slightly smaller in diameter than the larger upper disc 12, and whose topside indicia, as referenced above, may display days of the week or specific (or generic) times of the day for medication dosage tracking (e.g. hours of the day, whether in equal 1, 2, 3, 4, 6, 8 or 12-hour intervals or any other interval; or categorized times of the day, such as a.m. and p.m., morning and night; morning and afternoon; morning, afternoon and night; or morning, noon, afternoon and night). The underside of the lower disc 10 optionally may have an adhesive thereon used for attaching the tracker to medication containers 100, which adhesive will typically be covered initially by a removable backing 28. For a preassembled medication tracker, the removable backing 28 may have an optional slit 32 therein (see FIG. 5) for the purpose of maintaining an integrity of the adhesive until exposed by removal of the backing 28 to enable adhesive installation onto the container 100.

The shaft assembly 16 may be embodied in two-piece securing pin, a top piece 16A of which embodies the stopper 20 and a bottom piece 16B of which embodies the shaft 18 and base 22, where the shaft 18 of the first piece is inserted through central holes in the lower and upper discs from the underside of the lower disc 10, and the top piece or stopper 20 is fitted onto the shaft 10 over the topside of the uppermost one of the one or more upper discs 12, 24. This simple pin mechanism of the illustrated embodiment secures the bodies together in formation of a singular unity product, preventing loss of any of its component parts, while allowing the bodies to rotate relative to each other. While the illustrated example uses a two-piece pin or shaft assembly, a single-piece component may alternatively be employed for equivalent purpose. The pin or shaft assembly will typically be of a plastic or metal composition. In the illustrated example, at least the top piece of the securement pin is compose of transparent plastic, thus permitting viewing therethrough of any readable content on the underlying upper disc that would otherwise be obstructed from view, though in other embodiments, the top piece of the securement pin may be opaque, and the readable content of the underlying upper disc and the size of the upper piece of the securement pin appropriately laid out and sized to avoid such obstruction.

The assembled medication tracker 2A of FIGS. 2A and 2B features assembly of selectable lower disc 10E and selectable small upper disc 24A from the modular kit of FIG. 1, without one of the large upper discs 12A-12F. A pointer mark 36 (e.g. triangle, diamond, arrow or other similarly pointed marker) displayed on the topside of the smaller upper disc 24A near the outer perimeter thereof points at a selected one of a circular array of time indicia displayed on the topside of the lower disc 10E, whereby user rotation of the small upper disc 24A changes which of these indicia is pointed to as an indication of the latest or future administration time for the medication in the medication container 100 on which the tracker 2A is installed.

The assembled medication tracker 3A of FIGS. 3A and 3B instead features assembly of selectable lower disc 10E with selectable large upper disc 12A from the modular kit of FIG. 1, without either of the small upper discs 24A, 24B. The cut-out window 26 in the large upper disc 12A reveals a selected one of the circular array of time indicia displayed on the topside of the lower disc 10E, whereby user rotation of the large upper disc 12A changes which of these indicia is pointed to as an indication of the latest or future administration time for the medication in the medication container 10 on which the tracker 3A is installed. FIGS. 2A and 3A demonstrate how a same selected one of the various lower discs 10A-10E can be functionally compatible with either a large upper disc 12A or small upper disc 24A. The circularly arrayed indica on the topside of the lower disc 10E are situated at a radial distance from the center of lower disc 10E (and the rotational axis 14 embodied thereat) that both corresponds to the radial positioning of the cut-out windows 26 in the large upper discs 12A-12F and slightly exceeds the outside radial measure of the small upper disc 24A having its perimeter-adjacent pointer mark 36.

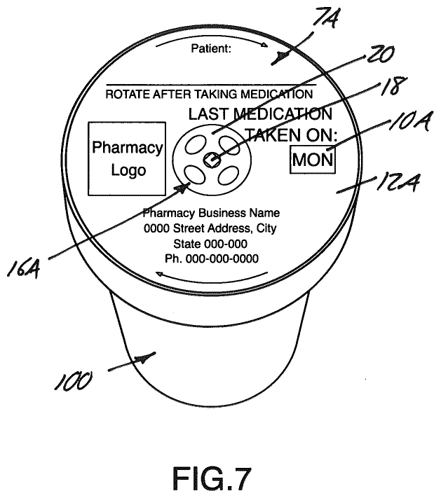

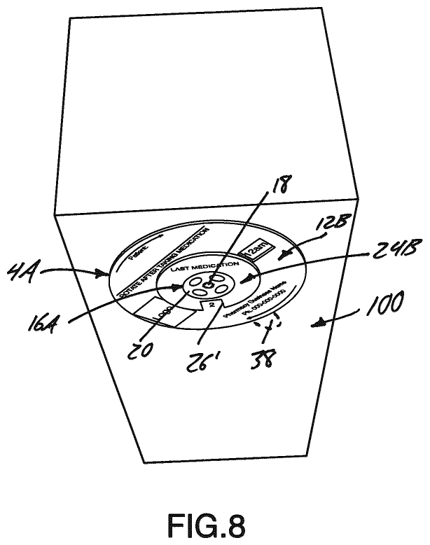

FIGS. 2A and 3A demonstrate how a same selected one of the various lower discs 10A-10E can be functionally compatible with either a large upper disc 12A or small upper disc 24A. The circularly arrayed indica on the topside of the lower disc 10E are situated at a radial distance from the center of lower disc 10E (and the rotational axis 14 embodied thereat) that both corresponds to the radial positioning of the cut-out windows 26 in the large upper discs 12A-12F and slightly exceeds the outside radial measure of the small upper disc 24A having its perimeter-adjacent pointer mark 36. The assembled medication tracker 7A of FIG. 7 is similar to that of FIG. 3A, differing only in its substitution of lower disc 10A from the kit of FIG. 1 in place of the lower disc 10E thereof, where the FIG. 3A scenario tracks time of day of a medication, whereas the FIG. 7 variant tracks daily consumption of a once-a-day medication with no designated time of day.

The assembled medication tracker 4A of FIGS. 4A and 4B instead features assembly of selectable lower disc 10E with selectable large upper disc 12B from the modular kit of FIG. 1 and selectable small upper disc 24B. The cut-out window 26 in the large upper disc 12A reveals a selected one of the circular array of time indicia displayed on the topside of the lower disc 10E, whereby user rotation of the large upper disc 12A changes which of these indicia is pointed to as an indication of the latest or future administration time for the medication in the medication container 100 on which the tracker 4A is installed. This large upper disc 12B, instead of time related indicia, has dosage related indicia circularly arrayed thereon. The small upper disc 24B has another a cut-out window 26′ therein of similar purpose to that in the illustrated larger upper disc 12, but in this case used for visual reveal of a selected one of the dosage indicia on the underlying large upper disc 12B, each of which is representative of a different dosage size (e.g. number of pills, or other quantification of dosage measurement, e.g. number of teaspoons of a liquid medication) or dosage count quantity (number of doses consumed in a day). This cut-out window 26′ of the small upper disc 24B is placed at a location intersecting the outer perimeter of the small upper disc, so that one side of the window 26′ is open at the perimeter of the disc, unlike the fully-bound windows 26 of the illustrated large upper discs 12A-12F. That said, the size and placement of the windows, and corresponding placement of the indicia visible through those windows, may vary among different embodiments.

With reference to FIG. 6, in alternative to inclusion of adhesive on the underside of the lower disc 10, a separate adhesion disc 30, optionally made of Printable Material and/or foam, may included for the adhesive bonding of the Printable Material medication tracker to the container 100, and may be embodied once again in a disc shape of circular outer perimeter. An adhesively coated underside of the adhesion disc 30, is usable to secure the tracker to the container 100, typically after reveal of this adhesively coated underside by removal of an initially present backing layer 28 of the same type alternatively included on the lower disc 10 in adhesively equipped embodiments thereof. As shown, such backing layer 28 may optionally have a predefined slit 32 therein, for example running diametrically of the circular disc shape of the lower disc 10 or adhesion disc 30, for easily peeling off the backing layer 28 at the time of installation onto the container 100. The illustrated example shows the adhesion disc 30 residing across the base 22 of the shaft assembly from the lower disc 10, in adhesively bonded relationship to the underside of the base 22, through the adhesion disc 30 could alternatively be annular in shape, with a central hole therein to accommodate the shaft 18, and could thus reside between the base 22 and the first body 10 in instances where the adhesion disc 30 is larger in outer diameter than the base 22.

As mentioned above, the small upper disc 24, in embodiments including both upper discs 12, 24, instead of being used to track medication dosage size, can alternatively be used to supplement the timing indication provided by cooperation of the lower disc 10 and large upper disc 12 with a further timing breakdown. In such cases, one of either the large upper disc 12 or the small upper disc 24 is provided with timing indicia whose timing intervals are of sub-scaled relation to the indicia on the other. As mentioned above, selectable small upper disc 24A of FIGS. 1 and 2A has a simple pointer mark 36 thereon that is selectively pointable to any one of the indica on the larger upper disc via rotation of the small supper disc 24A relative to the large upper disc 12, while selectable small upper disc 24B instead has a cut-out window 26′ therein of equivalent purpose to that in the large upper discs 12A-12F for visual reveal of a selected subset of the indicia on the underlying large upper disc 12.

As shown in broken lines, the large upper disc 12 may feature an actuation tab 38 of outwardly protruding relationship to a (typically circular) remainder of the disc's outer perimeter, which actuation tab 38 projects radially beyond the outer perimeter of the underlying lower disc 10 to make the large upper disc 12 easier to manually grip for the purpose of rotating the large upper disc 12 relative to the lower disc 10.

Having described the componentry and assembly of the Printed Material medication tracker, attention is now turned to the functional use thereof. In instances where the medication tracker includes only one of the large upper disc 12A or one of the small upper discs 24A, but not both, the user manually rotates the large upper disc 12A or the small upper disc 24A over the lower disc 10 each time the medicine is administrated. As the large upper disc 12A or small upper disc 24A rotates, the cut-out window 26 in the large upper disc 12A reveals, or the pointer mark 36 on the small upper disc 24A points to, different indicia (days, or times of day, by hour or category) on the lower disc 10, among which a chosen one of those indicia is selected for visible alignment with the cut-out window 26 or pointer mark 36 as tracked indication of either when the latest dose of medication was taken, or when the next dose of the medication is due. In embodiments including both one of the large upper discs 12C-12F with timing indicia thereon and the small upper disc 24B functionally compatible with such indicia on the large upper disc 12C-12F, the user manually rotates the small upper disc 24B over the large upper disc 12C-12F to similarly reveal, or point to, a selected indicia on the large upper disc 12C-12F as one of two complimentary indicators of when the latest dose of medication was taken or the next dose of the medication is due, the other complimentary indicator of which is given by the timing indicia on the lower disc, indicated by the first upper disc 12C-12F, so that the combination of the two complimentary indicators provides a more thorough definition of that dosage time.

Another one of the large upper discs 12B has dosage indica thereon instead of timing indicia, and the small upper disc 24B compatible with such indicia on the large upper disc 12B, the smaller upper disc 24B is rotated with each dose if being used to track quantity of doses per day (FIG. 4A), or is rotated only in instances where the dosage measurement varies between two sequential administrations of the medication if being used to track dose measurement per administration. In instances, like that shown in FIG. 9, where the lower disc 10A has days of the week indicated thereon and the large upper disc 12D, 12E, 12F has times of the day thereon for indication thereon by a compatible small upper disc 24B to track multiple administration times per day, then the rotation of the large upper disc 12D-12F to change the indicated day is only performed either after the last dose of a given day (when using the device to indicate the next scheduled administration of the medication) or after the first dose of a given day (when using the device to track the last completed administration of the medication), thus resetting the device for a new day, while the small upper disc is rotated at each administration time

Particularly unique or beneficial aspects of the novel Printed Material medication tracker are emphasized as follows.

Unconventional material Choice: Durable materials like plastic or metal are the norm in medication tracking devices. Though the use of comparably flimsy Printable Material may be counterintuitive, it makes the tracker lightweight, recyclable, and eco-friendly. Its economical production makes it feasible to be distributed for free or at a low cost especially at low production volumes or batches.

Customization: The Printable Material allows for easy customization of the tracker, including medication names, dose, patient information, personalized schedules, instructions, pharmacy and medication branding, etc. without modifying the manufacturing processes and/or setups. Printable Material is easier to print with standard printing techniques when compared with most plastics or other materials for which more complex processes are used to label the same.

Adjustable size: The tracker can be adjusted during the customization phase to fit different sizes of medication containers without modifying the manufacturing setups and processes. The cut-out window on any given disc equipped with such window can also be easily adjusted to show more or less of the underlying disc behind it.

Modular Design: As demonstrated by the modular kit example shown in FIG. 1, the tracker is a modular system, in which different variations of the lower disc with different indicia thereon can each be interchangeably substituted into combination with any variant of the second or third bodies, either of which can be added or removed according to the user's needs.

Integration with existing products: The tracker can be easily integrated with existing medication containers.

Ease of Use: Designed to be user-friendly, intuitive, and easy to assemble, making it accessible to a broad range of users, including those less comfortable with high-tech solutions, complex devices or gearing systems.

Versatility: The tracker can be adapted to various types of medication packaging, enhancing its applicability, including top of bottle caps and medication boxes. The flexibility of the Printable Material with adhesive compared with rigid plastic or other rigid materials, which are not flexible to be able to conform to an underlying surface, makes it easier to adhere directly to non-planar surfaces, such as tops of bottle caps or other surfaces with embossed or textured letters or graphics, which are common in many containers. Plastic or rigid materials typically use foam adhesives or other intermediary material to mold to the underlying mounting surface for attachment thereto.

Environmental Impact: Being a Printable Material, the tracker is a step towards sustainable solutions in medication management. Its primary components can be made of biodegradable materials and have a smaller environmental footprint compared to alternatives made fully of plastic or metal.

Target Audience: The primary users of this tracker include patients who need to manage their medication schedules, caregivers, health care providers and pharmacies or medication manufacturers/distributors that can distribute these trackers to enhance patient care and medication adherence.

Interactive Personalization: A service can be offered where the customer (patients, caregivers, healthcare providers, pharmacies or medication manufacturers/distributors) can design their tracker online before printing, adding a level of interactivity and personalization. That can include healthcare provider-/Pharmacy-/Medication-specific customization, tailoring the tracker for specific healthcare provider/pharmacy/medication chains with their branding and specific medication schedules. Those can be done in small batches/volumes and without modifying the manufacturing steps. The Printable Material also allows handwriting or stamping to differentiate between users in the same household, which is not possible with non-fibrous materials which are not suited to absorb Ink.

Durability, lifespan and single treatment use: Though the Printable Material medication tracker can be reused, it is primarily designed for a typical medication cycle duration (e.g. 5 to 90 days, etc.), therefore resisting recontamination after treatment.

Easy to manufacture, print and customize as compared to most plastics or other rigid, non-fibrous products.

Assembly process is relatively easy, offering three alternatives: pre-assembled during manufacturing with or without optional adhesive; assembled by the intermediary and end-user assembled.

Easy assembly, modular design and customization options give several variations and options for tracking and options for tracking the specific medication. Especially as this can be done by the intermediary or end-user.

Manufacturing process is simpler and less energy-intensive than current alternatives.

Does not interfere with the procedure of opening child proof bottles.

Lightweight character facilitates cost efficient shipping and handling.

Printable Material has a preconceived notion of being non-suitable to the daily use of the tracker as it does not provide a barrier to moisture, but this tracker is primarily intended to have a lifespan of the medication cycle duration, in addition, the Printable Material can be treated in increase durability to moisture if desired. Some of the Printable Materials are resistant to moisture and can be disinfected after use.

The tracker's layout includes clear, legible text and graphics, such as days of the week or dosage times, healthcare provider/pharmacy/medication branding and usage instruction. The design can also accommodate patient information, medication names, medication dose, educational content, pharmacy related information and QR codes for digital integration.

In terms of product lifecycle, the following is a non-limiting example of different phases within such lifecycle.

Intermediary: The product will typically be sold in bulk to healthcare providers, pharmacies, drug store retailers or medication manufacturers/distributors. The healthcare provider/pharmacy/retailer/manufacturer/distributor then will give away, incorporate into their own products or sell the tracker to the end user.

End Users: Patients, caregivers, healthcare providers and pharmacists.

Method of Installation: Attached to medication packaging using the adhesive in the lower disc or dedicated adhesion pad.

Operation: Users manually rotate the uppermost one or two of the bodies to track medication schedules.

User Interaction: The user interaction occurs after the patient takes the medication through simple disc rotation.

Maintenance: Reusable for new medication cycles or disposable after use.

Assembly of the tracker is straightforward, and may occur at different times in the lifecycle, including pre-assembly at the point of manufacturing with or without optional adhesive, assembly by the intermediary, or assembly by the end-user.

The durability and anticipated lifespan of preferred embodiments is sufficient so span the duration of typical medication cycle (e.g., 5 to 90 days).

Additionally, regarding the incorporation of marketing indicia for healthcare providers, pharmacies or medication manufacturers/distributors, the customization process can be done at the manufacturing stage of the tracker, at the medication manufacturer/distributor facility or at the pharmacy/healthcare facility. The design of the Printable Material Medication Tracker allows for flexible printing options, enabling each batch to be tailored with specific pharmacy branding, contact information, or any other desired content. This customization can occur during the initial manufacturing of the basic components (the discs/bodies and securing pin), post manufacturing but before final assembly (custom printing on, or application of stamps or stickers to, the discs/bodies) or after final assembly by small stickers or handwritten content. In addition to the capability to be customized directly at the healthcare facility, pharmacy or medication manufacturer/distributor, a system can also be set up where healthcare providers, pharmacies or medication manufacturers/distributors can place orders with their specific branding requirements, and these details will be printed onto the trackers in a designated production run dedicated to customized orders. This approach ensures that each intermediary receives trackers that are personalized for their specific marketing needs while maintaining the efficiency of the manufacturing process.

According to one variation, the tracker can be part of the medication container (e.g. flat wall of a medication box, or flat top of a pill bottle lid), eliminating the need of the adhesively mountable lower disc. In this case, the indicia typically embodied on the lower disc (days of the week or specific or generic times for medication tracking) can instead be printed directly on the medication container and the Securing Pin or shaft assembly will secure the rotatable disc(s) on the medication container. The component on which those indicia are provided may be generally referred to as a lower body, which may be embodied by lower disc such as those illustrated in the drawings, or by a part of the medication container itself.

According to one variation related to supply and use of the tracker, the two or more discs are printed directly at the pharmacy/distributor/healthcare provider. The upper discs can be templated on standard paper sizes (Letter, Tabloid, Legal, A4, A3, etc.) for a standard printer, with the templates having predefined perforations that would allow the individual upper discs to be easily and cleanly detached after printing. The view window and center hole for the Securing Pin or shaft assembly, for any of the templated discs equipped therewith, may also have perforations, or be precut.

Furthermore, adhesively backed lower discs may also be templated on standard paper sizes (Letter, Tabloid, Legal, A4, A3, etc.) for a conventional printer and to be printed at the pharmacy/distributor/healthcare provider. The adhesive backed Printable Material for the lower disc could be a kiss cut sticker sheet where the outer perimeter of the disc, and the center hole thereof for the shaft assembly or securing pin, are pre-cut only in the top printable layer of the sticker sheet, and not through the backing layer that covers the adhesive backside of the top printable layer.

There is also disclosed herein a method for tracking medication to be administered, which generally comprises the steps of:
providing a tracker for indicating a latest completed, or next scheduled, administration time of the medication;
attaching the tracker to the container; and
personalizing the tracker which can include (i) patient information, (ii) medication information including, for example, dosage information, and (iii) pharmacy, healthcare provider (e.g. clinic), or medication manufacturer information, for example including at least one of a logo of the pharmacy, healthcare clinic or medication manufacturer and contact information of the pharmacy or healthcare provider, and/or one or more QR codes or other machine-readable codes, for example having encoded therein a hyperlink to a webpage associated with the pharmacy, healthcare provider or particular medication, for example instructional video or written content concerning the particular medication (e.g. side effects, drug interactions, etc.) and its method of administration, or marketing material or online catalogue of the pharmacy.

Preferably, the step of providing a tracker comprises receiving a tracker in a manufactured state bearing indicia representing times at which the medication is to be administered or was last taken.

Personalizing the tracker may be performed by marking the tracker, or a sticker applied thereto, using Ink, whether such ink is applied by handwriting with a handheld writing utensil (e.g. pen or marker), or use of a printer or a stamp.

The method may further include discarding the container with the tracker attached thereto. As such, the tracker is a disposable device, and since its largest components (by volume) are the Printable Materials, the device can be made of biodegradable material.

When the tracker is provided in the form of a kit of plural constituent components, the step of providing a tracker comprises receiving the kit in a disassembled state, in which the constituent components are disconnected, and the method then includes a step of assembling the kit to form the tracker. Assembly of the kit may be performed prior to attaching the tracker to the medication container, such that the tracker is attached in an assembled state in which it is already operational for use to indicate a future administration time of the medication or when the medication was last taken. The lower disc and part of the shaft assembly can also be attached to the medication container prior to full assembly.

The kit comprises at least first stationary disc or other body, at least one rotational upper disc configured for rotational movement relative to the first disc or other body and optionally a second rotational upper disc configured for rotational movement relative to the first upper disc, and an interconnecting shaft assembly to support the upper rotational disc(s) in the rotational movement relative to the first body disc or other body, and to each other in the instance of two upper discs.

The scope of the claims should not be limited by the preferred embodiments set forth in the examples but should be given the broadest interpretation consistent with the specification as a whole.

1. A device for tracking administration of medication stored in a container, the device comprising:
a lower body configured to reside in stationary relationship to said container, and having a topside carrying indicia that are representative of timing intervals among which the medication is to be administered;
one or more upper discs, including at least a first upper disc having an underside arranged to face the lower body and an opposite topside arranged to face away from the lower body and the container, wherein the first upper disc is supported for rotation relative to the lower body and about a rotational axis projecting from the topside of the lower body and intersecting a plane of the first upper disc within a periphery of the first upper disc, wherein the first upper disc is configured to cooperate with the indicia on the topside of the lower body to indicate, to a user and from among said timing intervals, an administration time of the medication;
wherein at least one of the upper discs is made of Printable Material so as to be configured to receive Ink for personalizing the device.

2. The device of claim 1 wherein the lower body is made of Printable Material so as to be configured to receive Ink for personalizing the device.

3. The device of claim 1 wherein the one or more upper discs are rotatably connected to the lower body by a shaft assembly including a shaft defining the rotational axis and at least one stopper supported at or adjacent an end of the shaft and in distal relation to the lower body, so as to resist axial movement of the one or more upper discs away from the lower body.

4. The device of claim 3 wherein the shaft assembly includes a base at or adjacent a fixed end of the shaft opposite to the distal end thereof, wherein the base is in the form of a planar member oriented in a substantially radial plane of the rotational axis.

5. The device of claim 4 wherein the base is disposed to one side of the lower body and in opposite relation to the first upper disc so as to be arranged between the lower body and the container in a mounted condition of the lower body on the container.

6. The device of claim 4 further including an adhesive substrate attachable to the base of the shaft assembly in opposite relation to the lower body for bonding the shaft assembly to the container.

7. The device of claim 1 wherein the one or more upper discs include a second upper disc supported for rotation relative to the first upper disc about the rotational axis, wherein the second upper disc is disposed oppositely across the first upper disc from the lower body such that the first upper disc resides intermediately of the lower body and the first upper disc bodies along the rotational axis, wherein the topside of the first upper disc carries additional indicia representative of dosage quantities or additional timing intervals of different measure than those on the lower body, and wherein the second upper disc is configured to cooperate with the additional indicia on the topside of the first upper disc to indicate, to the user, dosage or supplemental timing information concerning said administration time of the medication.

8. The device of claim 7 wherein said additional indicia are representative of said additional timing intervals.

9. The device of claim 7 wherein the second upper disc is made of Printable Material so as to be configured to receive Ink for personalizing the device.

10. The device of claim 7 wherein the second upper disc is planar.

11. The device of claim 1 wherein the lower body and the first upper disc are planar.

12. A method for tracking administration of medication stored in a container, the method comprising:
providing a tracker for indicating an administration time of the medication; and
supporting the tracker on the container; and
before or after supporting the tracker on the container, personalizing the tracker

13. The method of claim 12 wherein providing a tracker comprises receiving a tracker in a manufactured state bearing indicia representing times at which the medication is to be administered.

14. The method of claim 12 wherein personalizing the tracker is performed by marking the tracker using Ink.

15. The method of claim 14 wherein marking the tracker using Ink comprises handwriting.

16. The method of claim 14 wherein marking the tracker using Ink comprises imprinting with a stamp.

17. The method of claim 15 further including discarding the container with the tracker attached thereto.

18. The method of claim 12 wherein, when the tracker is provided in the form of a kit of plural constituent components, providing a tracker comprises receiving the kit in a disassembled state, in which the constituent components are disconnected, and wherein the method further includes assembling the kit to form the tracker.

19. The method of claim 18 wherein the kit comprises a lower body configured to fixedly attach to the container, at least one rotational upper disc configured for rotational movement relative to the lower body, and an interconnecting shaft assembly to support the at least one rotational disc in the rotational movement relative to the lower body.

20. A method of assembling a medication tracker comprising:
from among a plurality of preprinted or templated options for a lower body of the medication tracker, each having thereon a uniquely different set of timing indicia thereon that represent medication timing intervals of different interval length from one set to another, choosing a selected one of said options based on a medication dosing schedule of an intended user; and
assembling, to a lower body component that embodied said selected one of said options, one or more rotatable upper discs in positions overtop said lower body in positions rotatable relative thereto, including at least a first upper disc configured cooperate with the set of timing indicia on the topside of the lower body to indicate, to a user and from among said medication timing intervals, an administration time of the medication; and
before or after assembling said lower body and said one or more upper discs, personalizing at least one of said one or more upper discs with personalized readable content specific to said user.
